(19) United States
(12) Patent Application Publication
(10) Pub. No.: US 2024/0421477 A1
(43) Pub. Date: Dec. 19, 2024

(54) ELECTROMAGNETIC ABSORBER APPLICATION TO RADAR RETROREFLECTIVE DEVICES

(71) Applicant: 3M INNOVATIVE PROPERTIES COMPANY, Saint Paul, MN (US)

(72) Inventors: Jaewon Kim, Woodbury, MN (US); Raymond P. Johnston, Lake Elmo, MN (US); John J. Sullivan, Hudson, WI (US); Shawn T. Brovold, Edina, MN (US); Matthew C. Messina, Maplewood, MN (US); Charles D. Hoyle, Stillwater, MN (US); Kenneth L. Smith, White Bear Lake, MN (US); Dipankar Ghosh, Oakdale, MN (US); Zhonghua Lu, Woodbury, MN (US); Robert A. Sainati, Bloomington, MN (US)

(21) Appl. No.: 18/717,909

(22) PCT Filed: Dec. 29, 2022
(86) PCT No.: PCT/IB2022/062884

§ 371 Date: Jun. 7, 2024

Related U.S. Application Data
(60) Provisional application No. 63/266,185, filed on Dec. 30, 2021.

(51) Int. Cl. H01Q 3/26; H01Q 17/00

(52) U.S. Cl. CPC H01Q 3/2647; H01Q 17/004

(57) ABSTRACT

Radar retroreflective (R3) devices including an electromagnetic absorber are provided. The electromagnetic absorber is disposed on selected areas of the device to reduce specular reflection without substantially reducing retroreflection of the device.

### BACKGROUND

Vehicle-based radar systems are widely used to detect objects or signs. Passive retroreflectors, such as Van Atta arrays, have become more and more accessible by providing capability of retro-directivity in wireless systems.

### SUMMARY

There is a desire to optimize passive radar retroreflectors to reduce interferences, e.g., from surrounding vehicles' radar signals and undesirable reflected signals by vehicles or objects. The present disclosure provides radar retroreflective (R3) devices including an electromagnetic absorber material to reduce the interference and enhance the retro-directivity.

In one aspect, the present disclosure describes a radar retroreflective (R3) device. The device includes a dielectric substrate including a first major surface and a second major surface opposite the first major surface: an antenna array of electromagnetic (EM) elements disposed on the first major surface of the dielectric substrate, the antenna array of electromagnetic elements being electrically interconnected to re-radiate back an incident EM wave with a retroreflection angle substantially in a direction of arrival; and an electromagnetic absorber disposed on the first major surface of the dielectric substrate.

In another aspect, the present disclosure describes a method including disposing an antenna array of electromagnetic elements on a first major surface of a dielectric substrate, the antenna array of electromagnetic (EM) elements being electrically interconnected to re-radiate back an incident EM wave with a retroreflection angle substantially in a direction of arrival; and disposing an electromagnetic absorber on the first major surface of the dielectric substrate, the electromagnetic absorber at least partially surrounding the antenna array of EM elements and configured to reduce the reflection of the incident EM wave without substantially reducing a retroreflection of the incident EM wave.

Various unexpected results and advantages are obtained in exemplary embodiments of the disclosure. One such advantage of exemplary embodiments of the present disclosure is that by applying an EM absorber to R3 materials/devices, the associated specular reflection can be significantly reduced while maintaining the retroreflection performance. Embodiments described herein can improve the signal-to-noise ratio (SNR) and enables clearer radar object detection.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic diagram illustrating reflection and retroflection from a radar retroreflective (R3) device, according to one embodiment.

FIG. 2A is a top view of a radar retroreflective (R3) device, according to one embodiment.

FIG. 2B is a cross-sectional view of a portion of the device of FIG. 2A.

FIG. 3A is a side perspective view of Example 1.

FIG. 3B is plots of reflection and retroreflection versus angles for Example 1.

FIG. 4A is a side perspective view of Example 2.

FIG. 4B is plots of reflection and retroreflection versus angles for Example 2.

FIG. 5A is a side perspective view of Example 3.

FIG. 5B is plots of reflection and retroreflection versus angles for Example 3.

FIG. 6A is a side perspective view of Example 4.

FIG. 6B is plots of reflection and retroreflection versus angles for Example 4.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

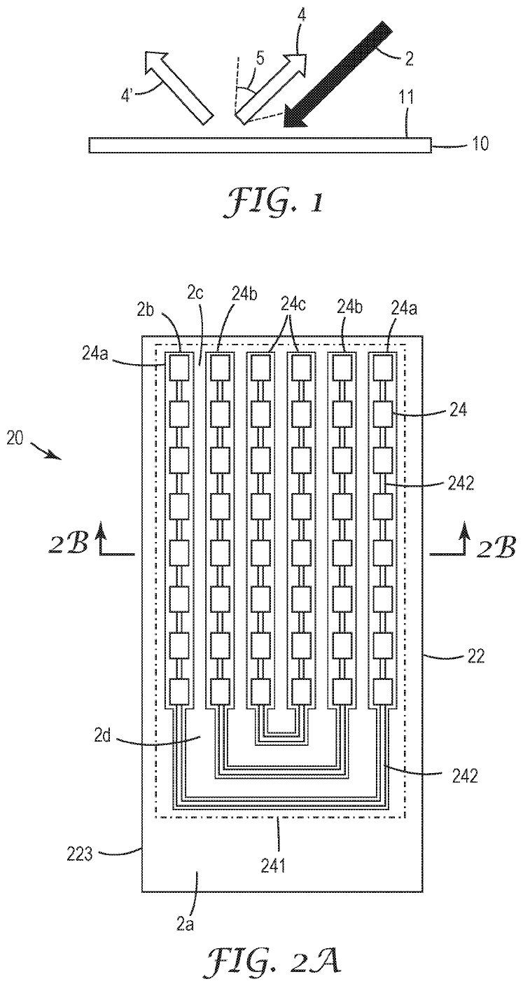

FIG. 1 is a schematic diagram illustrating reflection and retroflection from a radar retroreflective (R3) device, according to one embodiment. The radar retroreflective (R3) device 10 includes analog radio frequency (RF) components disposed on a major surface 11 thereof, configured to reflect an incident signal 2 from a source (not shown) towards the source direction, i.e., with a retroreflection angle 5 of the retroreflected signal 4 substantially in the direction of arrival. The acceptable retroreflection angle 5 may be in a range, for example, from −40 degrees to 40 degrees, or from −60 degrees to 60 degrees. The retro-directivity can be achieved by an antenna array of electromagnetic (EM) elements disposed on a dielectric substrate. One typical antenna array for achieving retro-directivity is a Van Atta array, which may include an array of antennas that are connected in symmetrical pairs by transmission lines of equal length or length differences equal to multiples of the guided wavelength. Exemplary structures of a Van Atta array and its method of making and use are described in, for example, “Van Atta Reflector Array,” E. D. Sharp and M. A. Diab, IRE Transactions on Antennas and Propagation, 436-438, 1960; and U.S. Pat. No. 2,908,002 (to L. C. Van Atta).

As shown in FIG. 1, in addition to the desirable retroreflected signal 4, there is also undesirable reflected signal 4′ from the device 10 upon the reflection of the incident signal 2 therefrom. In many cases, the reflected signal 4′ may be undesired because the reflected signal 4′ may not be reflected substantially in the direction of arrival, may not be detected, and may introduce interference. The present disclosure describes devices and methods to reduce the interferences, e.g., from surrounding vehicles' radar signals and undesirable reflected signals by vehicles or objects. In some embodiments, the antenna array re-radiates back the incident EM wave in a frequency range from 20 GHz to 130 GHz. It is to be understood that the radar retroreflective (R3) devices described herein may work for any desired radar frequency band such as, for example, 24 GHz frequency band, 76 to 77 GHz frequency band, 77 to 81 GHz frequency band, 79 GHz frequency band, etc.

In various embodiments, an electromagnetic absorber is provided on selected areas of a R3 device to reduce the specular reflection of the incident EM wave without substantially reducing a retroreflection of the incident EM wave from R3 device. While the electromagnetic absorber can reduce specular reflection by absorption, the electromagnetic absorber may have some side effects such as, for example, reducing retroreflection, shifting the angle of retroreflection, etc. Some embodiments in the present provide means to overcome the side effects. In some examples, the electromagnetic absorber may reduce a retroreflection of the incident EM wave from the device no greater than 10 dB, no greater than 5 dB, or no greater than 3 dB. In some examples, the electromagnetic absorber may reduce a reflection of the incident EM wave from the device no less than 1.5 dB, no less than 2 dB, no less than 3 dB, or no less than 4 dB. In some examples, the electromagnetic absorber may shift the retroreflection angle of the incident EM wave no greater than 20 degrees, no greater than 15 degrees, no greater than 10 degrees, or no greater than 5 degrees.

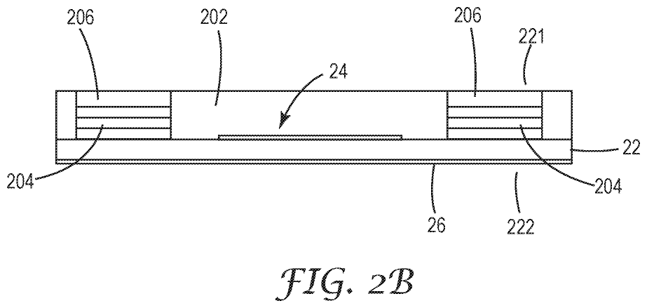

FIG. 2A is a top view of a radar retroreflective (R3) device 20, according to one embodiment. FIG. 2B is a cross-sectional view of a portion of the device of FIG. 2A. The device 20 includes a dielectric substrate 22 including a first major surface 221 and a second major surface 222 opposite the first major surface 221. The dielectric substate 22 may include any suitable dielectric material such as, for example, polytetrafluoroethylene (PTFE), or its composites.

An antenna array 24 of electromagnetic (EM) elements is disposed on or embedded in the first major surface 221 of the dielectric substrate 22. EM elements can be any electrically conductive patterns which can be either transparent or non-transparent. In some examples, an antenna array may include transparent conductive patterns. A conductive layer 26 is disposed on the second major surface 222 of the dielectric substrate 22.

The electromagnetic elements 24 are electrically interconnected by transmission lines 242 to re-radiate back an incident EM wave with a retroreflection angle substantially in a direction of arrival. Exemplary antenna array includes a Van Atta reflector array. In the depicted embodiment of FIG. 2A, the EM elements are connected to form three pairs of columns 24a, 24b and 24c. Each pair is positioned to form a symmetrical pattern. It is to be understood that the array of antennas can include any numbers of pairs and can be arranged in any desired patterns as long as they are connected in symmetrical pairs by transmission lines of equal length or length differences equal to multiples of the guided wavelength, i.e., the transmission lines do not contribute additional phase difference to incident waves.

An electromagnetic absorber is disposed on or embedded in one or more selected areas of the first major surface 221 of the dielectric substrate 22. As shown in FIG. 2A, the first major surface 221 of the dielectric substrate 22 can be divided into several types of areas 2a, 2b, 2c, and 2d as described below. A periphery area 2a of the dielectric substrate 22 substantially surrounds the antenna array 24. The periphery area 2a may refer to at least a portion or the whole of the space from the proximity of the antenna array 24 (as indicated by the dashed frame 241) to the edges 223 of the dielectric substrate 22. An antenna area 2b of the dielectric substrate 22 directly supports the antenna array of electromagnetic (EM) elements 24 and the transmission lines 242 connecting the EM elements 24. A first gap area 2c sits between and separates the adjacent columns of EM elements 24. A second gap area 2d sits between and separates the adjacent transmission lines 242. In some examples, the continuous area occupied by an antenna array on the substrate may refer to the total of the antenna area 2b, the first gap area 2c and the second gap area 2d. The periphery area 2a may substantially surround the continuous area of the antenna array. In some examples, the area ratio of 2a/(2b+2c+2d) may be in a range, for example, from 2:1 to 1:10, which may depend on the desired arrays of EM elements being used.

In some embodiments, the electromagnetic absorber may be disposed on or embedded in the periphery area 2a of the dielectric substrate 22. The electromagnetic absorber is disposed with a certain distance d away from the area 2b that supports the antenna array 24 (e.g., the area inside the frame 241). In some examples, the distance d may be in a range from λ/10 to λ, where λ is the wavelength of the incident EM wave. In the embodiment depicted in FIG. 2B, the EM absorber 202 is disposed on the periphery area 2a of the dielectric substrate 22 adjacent to the edges 223 thereof.

In some embodiments, the electromagnetic absorber may be disposed on or embedded in the first gap area 2c that sits between and separates the adjacent columns of EM elements 24. It is to be understood that the electromagnetic absorber may not contact to the EM elements 24 and the transmission lines 242. In the embodiment depicted in FIG. 2B, the EM absorbers 204 are disposed on the first gap area 2c between the adjacent EM elements 24.

In some embodiments, the electromagnetic absorber can be disposed on or embedded in the second gap area 2d that sits between and separates the adjacent transmission lines 242. It is to be understood that the electromagnetic absorber may not contact to the transmission lines 242.

The electromagnetic absorber described herein is disposed on or embedded in selected areas of the substrate surface and configured to reduce the specular reflection of the incident EM wave from the substrate without substantially reducing a retroreflection of the incident EM wave from the substrate. The electromagnetic absorber has suitable EM properties to absorb the incident EM wave and reduce the specular reflection. Exemplary electromagnetic absorber materials are described in, e.g., U.S. Patent Publication No. 2020/0053920 (to Ghosh), U.S. Pat. No. 9,704,613 (to Ghosh, Roy, and Satarkar), and “Structural and high GHz frequency EMI (Electromagnetic Interference) properties of carbonyl iron and boron nitride hybrid composites,” Mater. Res. Express 6, 106305 (2019).

Complex permittivity (εᵣ=ε′-jε″) are important parameters that can determine the microwave absorption properties of a composite, where the real parts of complex permittivity (ε′) represent the storage capability of electric energy, and the imaginary parts of permittivity (ε″) describe the loss capability of electric energy. Dielectric loss tangent values, where tan δ=(ε″/ε′), is often used to quantify loss values of a dielectric material. Generally, for achieving desired absorbtion performance, it is useful to keep the dielectric loss tangent (tan δ) values high while keeping the real part of permittivity, ε′, values low, to lower reflection.

In some embodiments, suitable composites can have a dielectric loss tangent in the range of, for example, about 0.05 to about 0.8, about 0.1 to about 0.8, about 0.2 to about 0.8, or about 0.25 to about 0.75 in the frequency band of interest. The high dielectric loss of the composites may be attributed to the high-loading-level of hybrid ceramic and conductive particles (e.g., CuO and carbon black particles). Preferable values for the dielectric permittivity are typically less than 10 in the frequency range of interest.

In some embodiments, a suitable absorber composite may include one or more ceramic filler materials. Exemplary ceramic filler materials may include at least one of cupric (II) oxide (CuO) or titanium (II) monoxide (TiO) in a polymer matrix with filler loading amount of 50 to about 95 wt. % in the composite. In some embodiments, an EMI composite may include a high-loading-level of ceramic particles (e.g., CuO particles) distributed in a suitable matrix material (e.g., polymer). In some embodiments, the polymer matrix material may include cured polymeric systems such as, for example, silicone, epoxy, cyclic olefin copolymer (COC), low-density polyethylene (LDPE), high-density polyethylene (HDPE), polystyrene (PS), polypropylene (PP), polyphenylene sulfide (PPS), polyimide (PI), syndiotactic polystyrene (SPS), polytetrafluoroethylene (PTFE), butyl rubber, acrylonitrile butadiene styrene (ABS), polycarbonate (PC), polyurethane, or a combination thereof.

In some embodiments, a suitable absorber composite may include a ceramic filler material and a conductive filler material. Exemplary conductive filler materials may include at least one of carbon black, carbon bubbles, carbon foam, graphene, carbon fiber, graphite, carbon nanotubes, metal particles, metal nanoparticles, metal alloy particles, metal nanowires, polyacrylonitrile fibers, or conductive-coated particles, with conductive filler loading amount of 0.1 to 3 wt. % in the composite.

In some embodiments, the electromagnetic absorber may include thermally conductive and electromagnetic absorption particles. Exemplary particles may include doubly layered core particles. Exemplary particles were described in U.S. Pat. No. 5,389,434 (to Griswold et al.), and PCT Publication No. WO2021/198849A1 (to Lu et al.). For example, particles may include Al₂O₃ as core, where middle layer is a thin conductive metal and the most outside layer is Al₂O₃ insulating layers. In some examples, the EM properties of an absorber can be controlled by controlling the particle loading volume in the composite. For example, with a particle loading volume of 45 vol %, an absorber may have a permittivity of ε′ no less than 8 and ε″ no less than 3.

The electromagnetic absorber can be formed on the selected areas of the substrate in single layer or multiple layers. It is to be understood that the electromagnetic absorber can be formed on the substrate surface, or embedded in the substrate adjacent to the substrate surface. In some embodiments, an electromagnetic absorber in single layer or multiple layers may have a thickness in a range, for example, from 0.01 mm to 10 mm, from 0.02 mm to 5 mm, or from 0.05 mm to 2 mm. It is to be understood that the thickness of the electromagnetic absorber may depend on the wavelength λ of the incident EM wave (e.g., an optimized thickness might be the quarter-wavelength).

In some embodiments, anti-reflection (AR) materials may be provided on electromagnetic absorber to further reduce the reflection therefrom. Referring again to FIG. 2B, an anti-reflection material 206 is provided on top of the electromagnetic absorber 204. Suitable anti-refection composites may include, for example, ceramic filler materials such as, for example, cupric (II) oxide (CuO) in a polymer matrix. In some examples, an AR composite may not include conductive fillers in its polymer matrix while an absorber composite may contain hybrid fillers, e.g., a mixture of ceramic CuO and conductive fillers in its polymer matrix.

An electromagnetic absorber and an anti-reflection material described herein can be applied to selected areas of the substrate surface by any suitable methods or processes. In one example, an electromagnetic absorber may include silicone composites with hybrid fillers, e.g., 50 to 80 wt. % of CuO and 0.6 to 1 wt. % carbon black, which can be prepared by processes of mixing, curing, pressing, etc. In one example, an anti-reflection material may include silicone composites with ceramic fillers, e.g., 20 to 80 wt. % of CuO, which can be prepared by processes of mixing, curing, pressing, etc.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Listing of Exemplary Embodiments

Exemplary embodiments are listed below. It is to be understood that any one of embodiments 1-10, and 11-15 can be combined.

Embodiment 1 is a radar retroreflective (R3) device comprising:
a dielectric substrate including a first major surface and a second major surface opposite the first major surface:
an antenna array of electromagnetic (EM) elements disposed on the first major surface of the dielectric substrate, the antenna array of electromagnetic elements being electrically interconnected to re-radiate back an incident EM wave with a retroreflection angle substantially in a direction of arrival; and
an electromagnetic absorber disposed on or embedded in the first major surface of the dielectric substrate.

Embodiment 2 is the device of embodiment 1, wherein at least a portion of the electromagnetic absorber is disposed on a periphery of the dielectric substrate, at least partially surrounding the antenna array.

Embodiment 3 is the device of embodiment 1, wherein the electromagnetic absorber comprises one or more ceramic filler materials, and optionally, one or more conductive filler materials in a polymer matrix.

Embodiment 4 is the device of embodiment 1, wherein the electromagnetic absorber comprises thermally conductive particles each having a conductive metal layer.

Embodiment 5 is the device of embodiment 1, further comprising an anti-reflection film on the electromagnetic absorber.

Embodiment 6 is the device of embodiment 5, wherein the anti-reflection film has a relatively lower dielectric constant and dielectric loss tangent than that of the electromagnetic absorber.

Embodiment 7 is the device of embodiment 1, wherein the electromagnetic absorber shifts the retroreflection angle of the incident EM wave no greater than 10 degrees.

Embodiment 8 is the device of embodiment 1, wherein the electromagnetic absorber reduces a retroreflection of the incident EM wave from the first major surface no greater than 3 dB.

Embodiment 9 is the device of embodiment 1, which reduces a reflection of the incident EM wave from the first major surface by at least 3 dB.

Embodiment 10 is the device of embodiment 1, wherein the antenna array comprises a Van Atta reflector array.

Embodiment 11 is a method comprising:
disposing an antenna array of electromagnetic elements on a first major surface of a dielectric substrate, the antenna array of electromagnetic (EM) elements being electrically interconnected to re-radiate back an incident EM wave with a retroreflection angle substantially in a direction of arrival; and
disposing an electromagnetic absorber on the first major surface of the dielectric substrate, the electromagnetic absorber being configured to reduce the reflection of the incident EM wave from the first major surface without substantially reducing a retroreflection of the incident EM wave from the first major surface.

Embodiment 12 is the method of embodiment 11, wherein the electromagnetic absorber is disposed on or embedded in a periphery of the first major surface, at least partially surrounding the antenna array.

Embodiment 13 is the method of embodiment 11, wherein the electromagnetic absorber reduces the retroreflection of the incident EM wave from the first major surface no greater than 3 dB.

Embodiment 14 is the method of embodiment 11, wherein the reflection of the incident EM wave from the first major surface is reduced by at least 3 dB.

Embodiment 15 is the method of embodiment 11, wherein the antenna array re-radiates back the incident EM wave in a frequency range from 20 GHz to 130 GHz.

### EXAMPLES

These examples are merely for illustrative purposes and are not meant to be limiting on the scope of the appended claims.

Radar retroreflective (R3) materials/devices were designed and simulated with the commercialized electromagnetic modeling tool, CST Microwave Studio from Dassault Systèmes (Waltham, MA, USA). A R3 device having a configuration as shown in FIG. 2A was designed. The R3 device has a dielectric substrate with a size of 31.6 mm×15.8 cm×0.127 mm. The dielectric substrate has a dielectric constant of 2.2. An antenna array of electromagnetic (EM) elements are provided on the substrate surface. The EM elements are arranged as six columns, each having eight elements. Each EM element has a size of 1.13 mm×1.263 mm. The transmission line has a width of 0.3 mm. The transmission line connecting the adjacent EM elements in each column has a length of 1.371 mm. The gap between the adjacent EM elements of the adjacent columns is 1.17 mm.

An EM absorber was applied to selected areas on the R3 device to reduce the specular reflection of the R3 device while maintaining the retroreflection of the R3 device. The EM absorber has a dielectric constant of 8 and a loss tangent (tan δ) of 0.25. The EM absorber thickness was swept from 0.1 mm to 0.5 mm. Four examples (Examples 1 to 4) were calculated at 77 GHz with different application areas on the top of the R3 material/device.

### Example 1

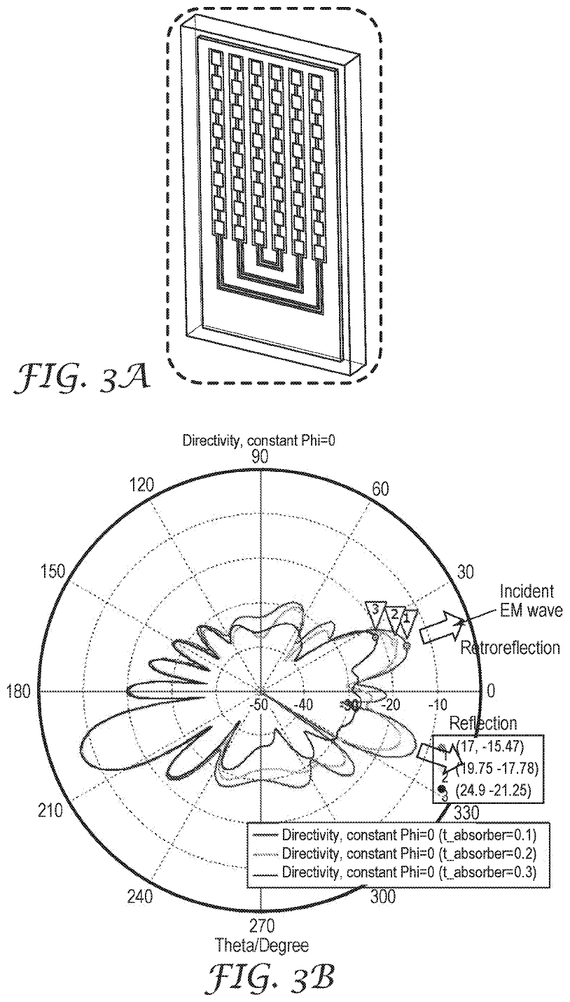

FIG. 3A is a side perspective view of Example 1. The EM absorber was applied on the whole surface except the area of the antenna array (EM elements and transmission lines connecting the EM elements). Referring to FIG. 2A, the applied area includes areas 2a, 2c and 2d. FIG. 3B is plots of reflection and retroreflection versus angles for Example 1. As shown in FIG. 3B, the reflection was significantly reduced by 16 dB with 0.3 mm thick EM absorber while the retroreflection is also reduced by 6 dB. The angle of retroreflection was also shifted by 5° to 10° due to the EM absorber between arrays (e.g., on the area 2c of FIG. 2A).

### Example 2

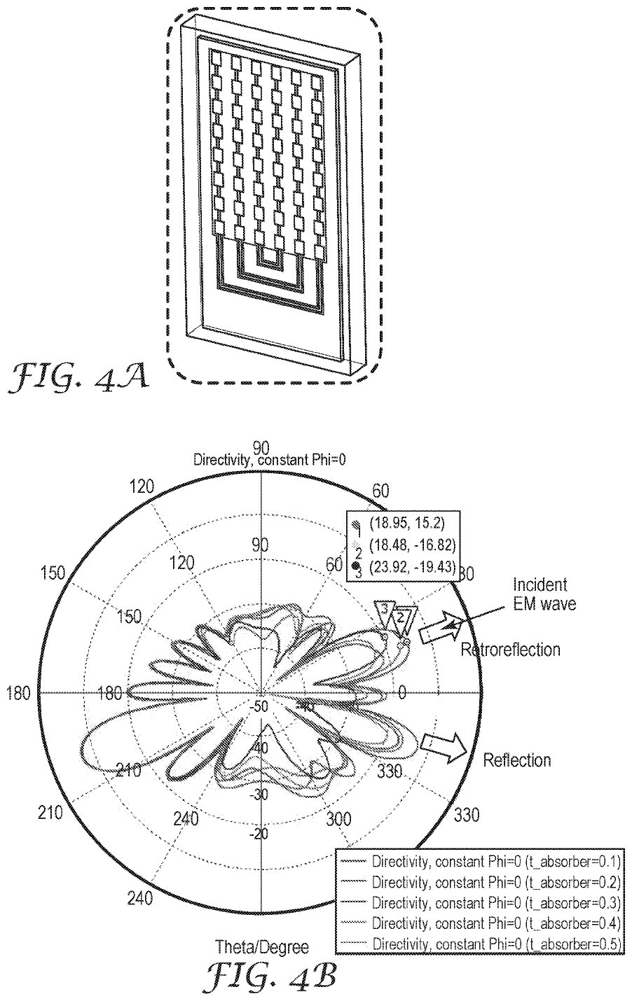

FIG. 4A is a side perspective view of Example 2. The EM absorber was applied on the surrounding areas and the center gap of the array. Referring to FIG. 2A, the applied area includes area 2a, the central gap of area 2c, and 2d. FIG. 4B is plots of reflection and retroreflection versus angles for Example 2. As shown in FIG. 4B, the reflection was significantly reduced by 25 dB with 0.3 mm thick EM absorber while the retroreflection was reduced only by 4 dB. As compared to Example 1, the angle of retroreflection was less shifted.

### Example 3

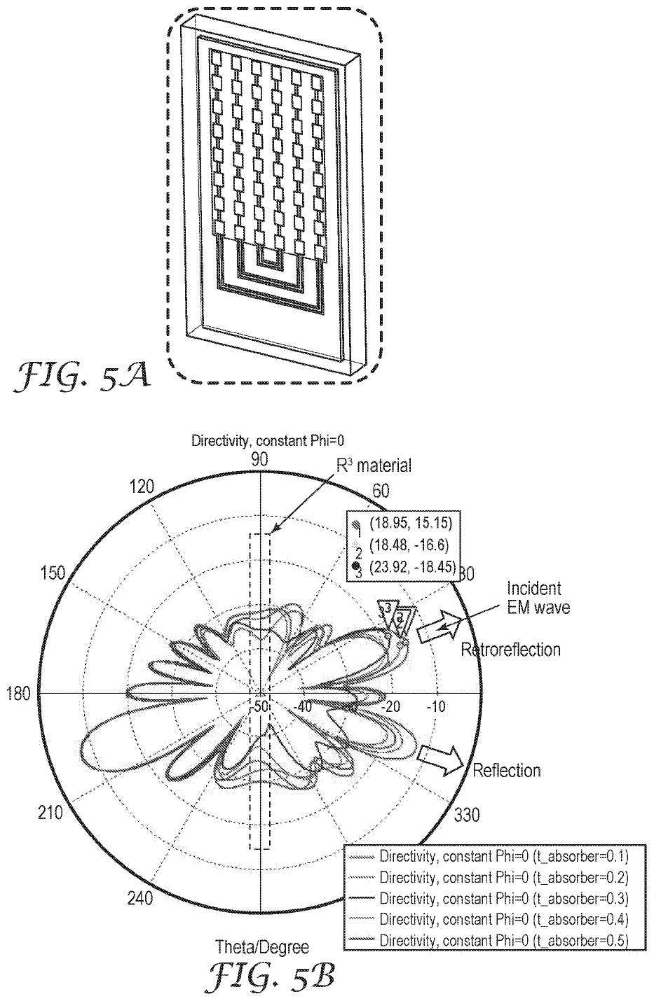

FIG. 5A is a side perspective view of Example 3. The EM absorber was applied on the surrounding areas that surround the antenna array (EM elements and transmission lines connecting the EM elements). Referring to FIG. 2A, the applied area includes area 2a, and area 2d. FIG. 5B is plots of reflection and retroreflection versus angles for Example 3. As shown in FIG. 5B, the reflection was significantly reduced by 20 dB with 0.3 mm thick EM absorber while the retroreflection was reduced only by 3 dB. As compared to Examples 1 and 2, the angle of retroreflection was less shifted.

### Example 4

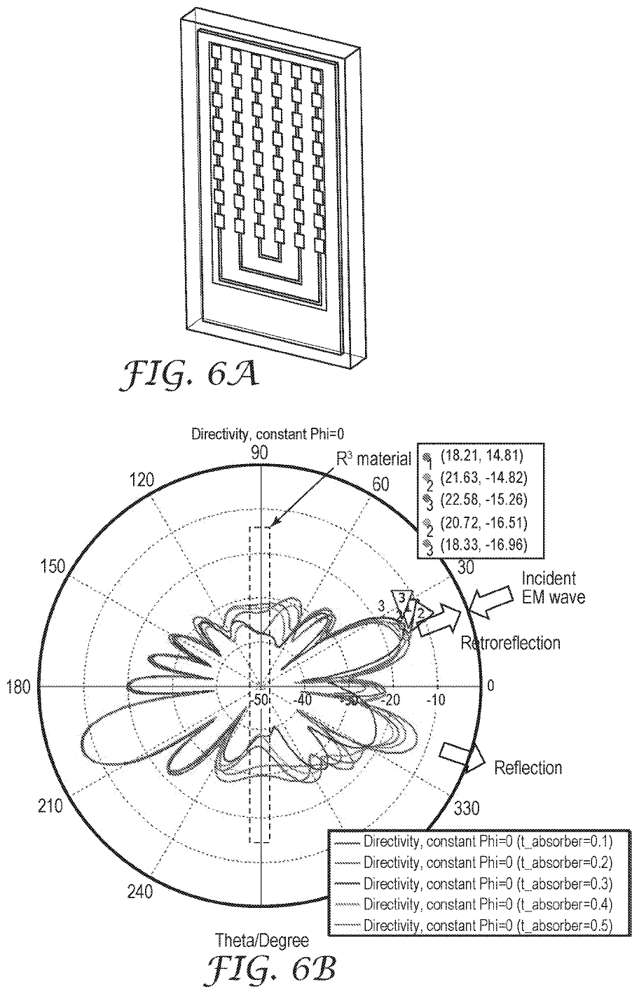

FIG. 6A is a side perspective view of Example 4. The EM absorber was applied on the surrounding areas that surround the antenna array (EM elements and transmission lines connecting the EM elements). Referring to FIG. 2A, the applied area includes only area 2a. FIG. 6B is plots of reflection and retroreflection versus angles for Example 4. As shown in FIG. 6B, the reflection was significantly reduced by 8 dB with 0.3 mm thick EM absorber while the retroreflection was reduced only by 0.5 dB. As compared to Example 3, the retroreflection strength is less affected by the EM absorber.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments. While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, various exemplary embodiments have been described. These and other embodiments are within the scope of the following claims.

What is claimed is:

1. A radar retroreflective (R3) device comprising:
a dielectric substrate including a first major surface and a second major surface opposite the first major surface:
an antenna array of electromagnetic (EM) elements disposed on the first major surface of the dielectric substrate, the antenna array of electromagnetic elements being electrically interconnected to re-radiate back an incident EM wave with a retroreflection angle substantially in a direction of arrival; and
an electromagnetic absorber disposed on or embedded in the first major surface of the dielectric substrate.

2. The device of claim 1, wherein at least a portion of the electromagnetic absorber is disposed on a periphery of the dielectric substrate, at least partially surrounding the antenna array.

3. The device of claim 1, wherein the electromagnetic absorber comprises one or more ceramic filler materials, and optionally, one or more conductive filler materials in a polymer matrix.

4. The device of claim 1, wherein the electromagnetic absorber comprises thermally conductive particles each having a conductive metal layer.

5. The device of claim 1, further comprising an anti-reflection film on the electromagnetic absorber.

6. The device of claim 5, wherein the anti-reflection film has a relatively lower dielectric constant and dielectric loss tangent than that of the electromagnetic absorber.

7. The device of claim 1, wherein the electromagnetic absorber shifts the retroreflection angle of the incident EM wave no greater than 10 degrees.

8. The device of claim 1, wherein the electromagnetic absorber reduces a retroreflection of the incident EM wave from the first major surface no greater than 3 dB.

9. The device of claim 1, which reduces a reflection of the incident EM wave from the first major surface by at least 3 dB.

10. The device of claim 1, wherein the antenna array comprises a Van Atta reflector array.

11. A method comprising:
disposing an antenna array of electromagnetic elements on a first major surface of a dielectric substrate, the antenna array of electromagnetic (EM) elements being electrically interconnected to re-radiate back an incident EM wave with a retroreflection angle substantially in a direction of arrival; and
disposing an electromagnetic absorber on the first major surface of the dielectric substrate, the electromagnetic absorber being at least partially surrounding the antenna array and configured to reduce the reflection of the incident EM wave from the first major surface without substantially reducing a retroreflection of the incident EM wave from the first major surface.

12. The method of claim 11, wherein the electromagnetic absorber is disposed on or embedded in a periphery of the first major surface, at least partially surrounding the antenna array.

13. The method of claim 11, wherein the electromagnetic absorber reduces the retroreflection of the incident EM wave from the first major surface no greater than 3 dB.

14. The method of claim 11, wherein the reflection of the incident EM wave from the first major surface is reduced by at least 3 dB.

15. The method of claim 11, wherein the antenna array re-radiates back the incident EM wave in a frequency range from 20 GHz to 130 GHz.
